(19) United States
(12) Patent Application Publication
(10) Pub. No.: US 2011/0145029 A1
(43) Pub. Date: Jun. 16, 2011

(54) TRACKING AND REPORTING CONSTRUCTION, COMPLETION, AND INSPECTION STATUS

(75) Inventors: William E. Clemenson, Venice, CA (US); Bernhard F. Kamps, Dartmouth (CA)

(73) Assignee: HTS, LLC, Los Angeles, CA (US)

(21) Appl. No.: 13/007,537

(22) Filed: Jan. 14, 2011

Related U.S. Application Data
(62) Division of application No. 11/689,449, filed on Mar. 21, 2007.
(60) Provisional application No. 60/784,636, filed on Mar. 21, 2006.

(51) Int. Cl. G06Q 10/00

(52) U.S. Cl. 705/7.11

(57) ABSTRACT

A user interface enables a user to associate a poly-line representation of a facility floor plan, having a plurality of shapes that correspond to contiguous areas of the facility floor plan, with a database of business parameters relating to condition of the contiguous areas. A report generator generates a visual representation of the facility floor plan that maps the business parameters of the database onto the contiguous areas of the poly-line representation and that modifies the visual representation in accordance with updated business parameters values of the database.

### CROSS-REFERENCE TO RELATED APPLICATIONS

This application is a Divisional application of U.S. patent application Ser. No. 11/689,449 to W. Clemenson et al., filed Mar. 21, 2007 entitled Tracking and Reporting Construction, Completion, and Inspection Status, which claims the priority benefit of U.S. Provisional Patent Application Ser. No. 60/784,636 to W. Clemenson filed on Mar. 21, 2006. Priority of these patent applications is claimed and the disclosures of the applications are incorporated herein by reference.

### BACKGROUND OF THE INVENTION

1. Field of the Invention

The present invention relates to the management of complex activities particularly those associated with the physical facilities of large organizations. More specifically, an embodiment of the present invention teaches management and reporting on construction completion and inspection status for large and complex organizations such as hospitals. The technology of the present invention can also be applied to all aspects of construction, commissioning, and transitioning utilized by large organizations such as hospitals, and provides a variety of methods, systems, and reporting mechanisms for accomplishing these tasks.

2. Description of Related Art

Due to the complexity of the physical plant facilities of large organizations, a separate category of service has evolved wherein expert practitioners oversee the processes of construction, commissioning, and transition planning of physical plants. Experts manage all aspects of construction, commissioning and transition planning, including construction completion, the inspection process, the correction of deficiencies identified by physical plant inspectors, commissioning completion, installation of IT equipment, and so forth.

One critical aspect of the construction management involves the tracking and correction or completion of “deficiencies” or “punches.” Those skilled in the art will recognize projects, etc. In the past, the inspection process has floundered because it lacked an efficient means of identifying construction completion and resolution of inspection issues identified by inspectors and other construction professionals.

What are needed are mechanisms and systems for managing and tracking complex business processes such as construction, commissioning and transition planning. In particular, what is needed are visual reports that provide construction and inspection status for an entire area or floor. Additionally, the prior art fails to teach a tagging system whereby deficiencies can be labeled where they occur in the physical plant and in the inspection record forms used by inspectors in the field, a computerized master list of deficiencies that can be sorted by room, type, and other criteria, a database in which to record the status of deficiencies and steps taken to complete or correct such deficiencies, and a means for generating visual reports that identify and locate deficiencies clearly. A cohesive teaching for tracking various dynamic construction, commissioning, and transition planning milestones such as installation of drywall, room inspection of deficiencies, installation of furniture and IT equipment, and the like.

From the discussion above, it should be appreciated that there is a need for mechanisms and systems for managing and tracking complex business processes such as construction, commissioning and transition planning. The present invention satisfies this need.

### SUMMARY

In accordance with the invention, embodiments of the invention provide a user interface that enables a user to associate a poly-line representation of a facility floor plan, having a plurality of shapes that correspond to contiguous areas of the facility floor plan, with a database of business parameters relating to condition of the contiguous areas. A report generator generates a visual representation of the facility floor plan that maps the business parameters of the database onto the contiguous areas of the poly-line representation and that modifies the visual representation in accordance with updated business parameters values of the database. In this way, the invention provides mechanisms and systems for managing and tracking complex business processes associated with facilities, such as construction, commissioning, and transition planning.

Embodiments of the invention provide techniques for associating a poly-line representation of a facility floor plan having a plurality of shapes that correspond to contiguous areas of the facility floor plan with a database of business parameters relating to condition of the contiguous areas, and for generating a visual representation of the facility floor plan that maps the business parameters of the database onto the contiguous areas of the poly-line representation. The visual representation can be modified in accordance with updated business parameters values of the database.

Other features and advantages of the present invention should be apparent from the following description of the preferred embodiments, which illustrate, by way of example, the principles of the invention.

### BRIEF DESCRIPTION OF THE DRAWINGS

These and other objects, features, and characteristics of the present invention will become more apparent to those skilled in the art from a study of the following detailed description in conjunction with the appended claims and drawings, all of which form a part of this specification.

FIG. 1 is a flow chart illustrating a method for managing business processes relating to the construction, commissioning, or transitioning of the physical plants of large organizations such as hospitals.

FIG. 2 is a flow chart illustrating the steps in the management of the database of box 106 in FIG. 1.

FIG. 3 is a flow chart illustrating the steps in the effectuation of the business process of box 110 in FIG. 1.

FIG. 4 is a sample colorized status report related to managing deficiencies according to one aspect of the present invention.

FIG. 5 illustrates a uniquely identifiable tag according to one embodiment of the present invention.

FIG. 6 illustrates several tags attached to deficiencies in the field.

FIG. 7 illustrates a blank inspection report according to another embodiment of the present invention.

FIG. 8 illustrates a partially completed inspection report according to still another embodiment of the present invention.

FIG. 9 illustrates several computer interface windows for the construction process management database according to the present invention.

FIGS. 10-11 illustrate another reporting style according to the present invention.

FIG. 12 is a block diagram representation of a system constructed in accordance with the present invention.

FIG. 13 is a flow chart that illustrates operations of the system illustrated in FIG. 12.

FIG. 14 is a flow chart that illustrates operations of the system illustrated in FIG. 12.

FIG. 15 is a block diagram that shows construction of the devices of the FIG. 12 system in accordance with the present invention.

### DETAILED DESCRIPTION

### I. Management Techniques for Construction, Commissioning, and Transitioning Facilities

### A. Features

The present invention contemplates a variety of methods and systems for tracking business process parameters related to the physical plants (facilities) of large organizations. More specifically, certain embodiments of the present invention contemplate a variety of methods and systems for the management of the construction, commissioning, and transitioning of large organizations such as hospitals. The present invention teaches all these features and provides other aspects through the use of a management database and colorized reporting.

When a large organization constructs a new facility or moves to a new facility, there is an inspection process in which inspectors report deficiencies in that facility to the contractor responsible for that facility. The contractor is responsible for correcting those deficiencies and obtaining verification from inspectors that those deficiencies have been corrected. According to one construction embodiment, the present invention uses a database to monitor the correction process.

A method for managing the construction process starts with a set of floor plans of the physical plant of the organization in question. The floor plans can be derived or taken from a variety of formats, such as computer-aided design (CAD) file formats, and could be of various types, such as architectural drawings or engineering drawings. In one embodiment, the floor plans are exported from CAD drawings to a graphics file format such as the file format of the Visio™ application available from Microsoft Corporation of Redmond, Wash., USA. The present invention teaches converting the drawings from a suitable format into poly-line images, uploads data into poly-line templates, and generates visual reports. For most construction applications, the floor plans are thus formed into a series of poly-line shapes that represent each room in the physical plant individually. Information regarding dynamic construction parameters and milestones such as installation of drywall, room inspection deficiencies, installation of furniture and IT equipment, and the like can then be mapped to the proper room and presented to the user through meaningful status reports such as colorized drawings.

According to one aspect of the present invention, each deficiency in each room that has been reported by an inspector may be associated with a tag number, a status, a description, and an organization that is responsible for the correction of that deficiency. This information is entered in a computerized master punch (deficiency) list that is used to track the status of inspections and to generate reports that can be sorted by a variety of criteria, including area, level, room type, responsible subcontractor, inspection type, deficiency type, or other custom criteria. The database enables the user to generate visual reports based on mapping business process parameters such as the information contained in the master punch list onto the poly-line image of the floor plans created by the poly-line locomotive.

In one embodiment, the visual reports based on the poly-line image of the floor plans show the number of open deficiencies in each room. The general contractor responsible for the construction, commissioning, or transitioning of the physical plant assigns each open deficiency that has been reported by an inspector to a subcontractor. The subcontractors use these reports to identify the problems for which those subcontractors are responsible. The subcontractors correct the deficiencies and report back to the general contractor, who then reports back to the inspectors. The inspectors then visit the physical plant to verify that the deficiencies have been corrected.

Changes in business process parameters such as the status of deficiencies are entered in the appropriate database. The process terminates when all deficiencies that have been reported by inspectors have been reported by those inspectors to have been corrected.

Similar tracking and reporting can be implemented using the teachings of the present invention for complex business processes such commissioning and transitioning.

The present invention contemplates a variety of improved techniques including techniques for management of the complex activities associated with the construction, commissioning, and transition planning of the physical plants of large organizations such as hospitals. For example, embodiments of the invention can use a master punch (deficiency) list to organize the inspection process, track the status of inspections, organize deficiencies by responsible organization, completion status, and location, and to make reports available to support management of the inspection process. The punch list contains a record of each deficiency reported by inspectors that includes a description of that deficiency, the status of that deficiency, and a tag identification number of that deficiency. In this way, the invention enables the user to generate master punch list reports that can be sorted by area; level, room type, subcontractor, inspection type, deficiency type, or other custom criteria.

Other embodiments of the invention include a commissioning tracking system to organize and track commissioning requirements contained in project specifications and to provide reports on the status of training, testing, warranties, and other commissioning matters. Embodiments also include a transition planning database that maintains detailed information on the status of room and equipment completion during the transition planning fitup process. Embodiments described herein also include a poly-line locomotive that converts architectural floor plans into series of poly-line shapes that represent each room in those floor plans. The poly-line locomotive also generates visual reports based on room status reports obtained during the inspection process. These visual reports produce color-coded views of rooms based on the number of deficiencies they contain and indicate the number of deficiencies associated with each room. Project-specific room types may also be highlighted in these reports. These reports and other features of the present invention enable to user to track each room individually as necessitated by the complexity and specialization of the rooms of large organizations.

### B. Exemplary Embodiments

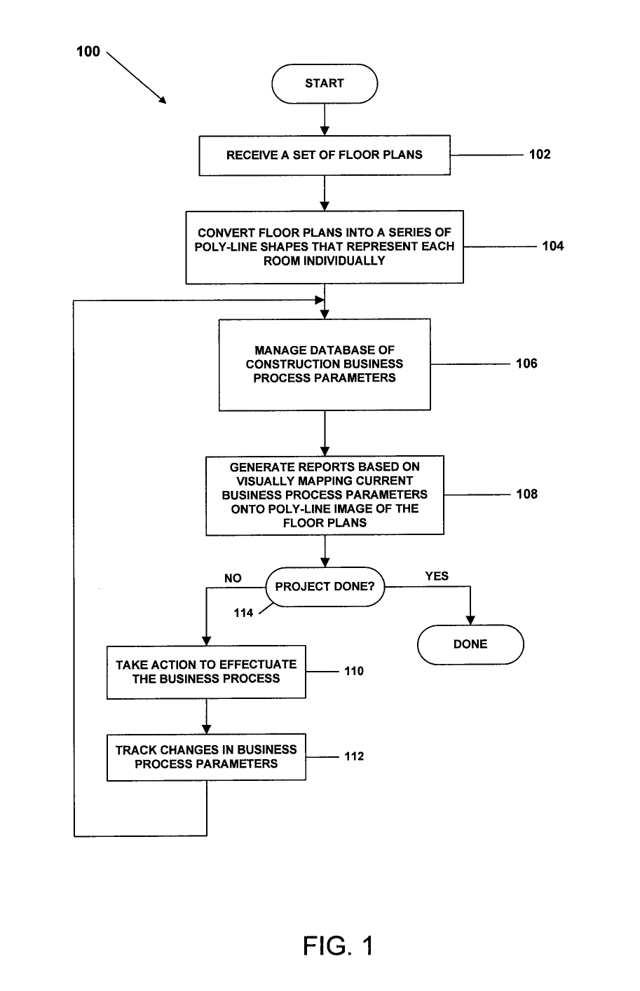

With reference to FIG. 1, a computer-implemented construction management method 100 for tracking construction business process parameters such as the status of deficiencies in the physical plants of large organizations such as hospitals will now be described. While the focus here is on tracking deficiencies during the construction process, those skilled in the art will readily recognize how the techniques disclosed herein may be applied and implemented in the context of a variety of complex business process.

In a first step 102, a set of floor plans of the facility in question is provided. The floor plans may be derived from a variety of formats, such as computer-aided design drawings, and may be of various types, such as architectural drawings or engineering drawings. In a next step 104, the provided drawings, be they computer-aided design and other drawings into poly-line images, uploads data into poly-line templates, and generates visual reports, to convert those floor plans into a series of poly-line shapes that represent each room individually. In one embodiment, the drawings are exported from CAD format into a graphics format such as Visio. The graphic format images are then converted into floor plans having p-line images representing each room individually.

Continuing in a next step 106, the user enters relevant data regarding the construction business process parameters being monitored in a database. Relevant data may include architectural room numbers, room names, room types, room locations, field observations such as the descriptions, identification numbers, and status of deficiencies, inspectors' notes, and other things.

Continuing in a next step 108, the user generates reports based on the visual mapping of current business process parameters onto the poly-line image of the floor plans. These reports may take the form of visual poly-line representations of the floor plans, and may provide such dynamic and static construction information as room numbers, the number and type of deficiencies associated with each room, the ownership of each room, the area, level, and type of each room, the subcontractor responsible for correcting indicated deficiencies, and so on. Rooms may be color-coded in these reports to convey such information as room type, room ownership, and the number of deficiencies associated with each room.

Continuing in a next step 114, the user determines whether the project of correcting the deficiencies has been completed. For example, if rooms having no open deficiencies are colored blue to represent completion in the reports of step 108, the user may check whether all rooms in the poly-line representation of the floor plans are colored blue.

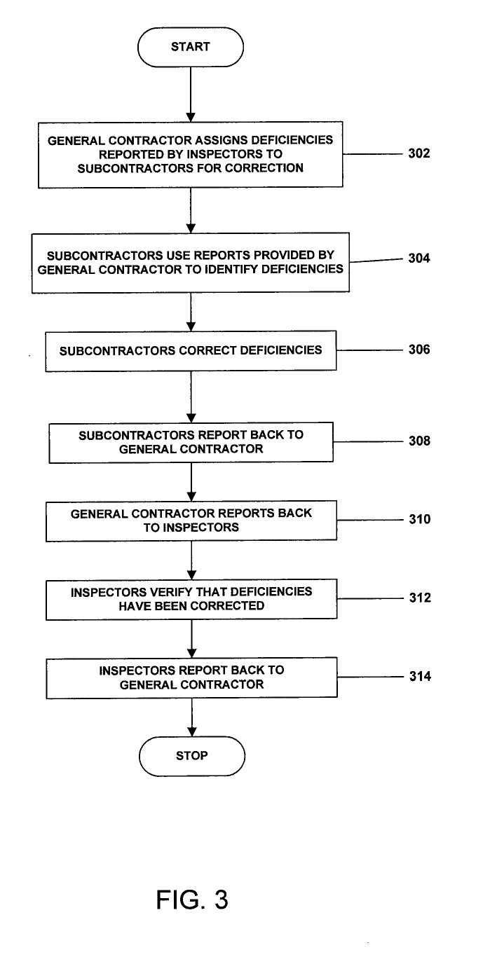

If the project has been completed, the user stops. If the project is still incomplete, in a next step 110, the user takes action to effectuate the business process (e.g., correct or complete deficiencies, tag a deficiency and enter related data into the database, etc.). An example of such action is described below with reference to FIG. 3. In a next step 112, the user tracks changes in the business process parameters being monitored, updating the database to reflect changes in dynamic parameters. In one embodiment, changes are tracked using detailed room status reports. When the changes have been tracked, the user returns to step 106.

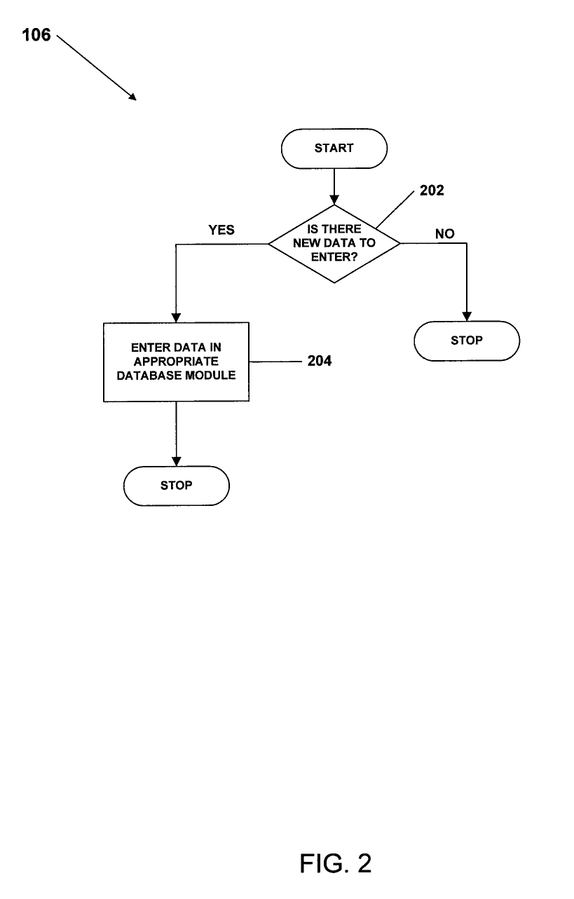

With reference to FIG. 2, one suitable method for implementing step 106 of FIG. 1 is as follows. In a first step 202, the user determines whether there is new data to enter into the database. The user may be an inspector, contractor, commissioner, or any other person have access to the database and participating in the construction process. If all data has been entered, the user may stop or may continue editing the database for other purposes. If there is addition data to update, in a next step 204, the user enters the data in the appropriate database. Database modules include the master punch (deficiency) list, the commissioning completion database, and the transition planning room completion database. When the data has been entered, the user stops.

With reference to FIG. 3, one deficiency correcting embodiment of step 110 from FIG. 1 is implemented as follows. In a first step 302, the general contractor or other user assigns deficiencies that have been reported by inspectors to subcontractors for correction. In a next step 304, those subcontractors use reports provided by the user to identify the deficiencies to be corrected. In a next step 306, the subcontractors correct those deficiencies.

Continuing in a next step 308, the subcontractors report back to the user, and in a next step 310, the user reports back to the inspectors. In a next step 312, the inspectors visit the facility to verify that the deficiencies previously reported have been corrected. In a next and final step 314, the inspectors report back to the user.

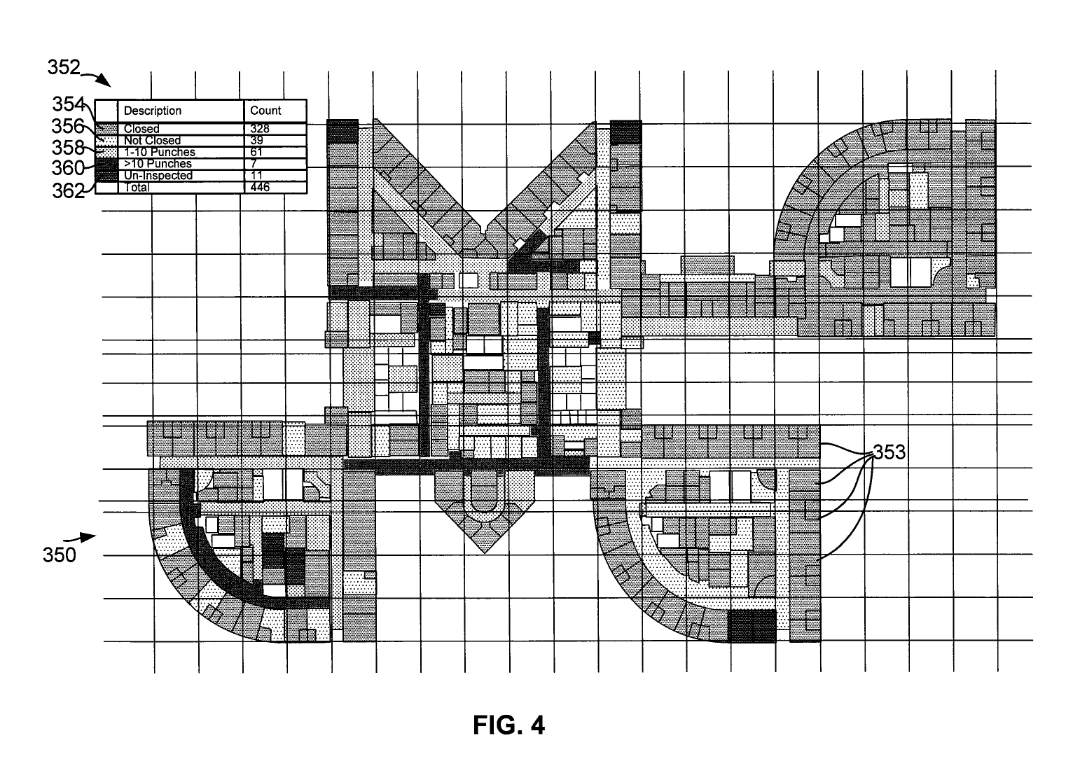

One sample report 350 will now be described with reference to FIG. 4. The sample report 350 maps room specific data on deficiency status, according to a color code indicated by a key 352, onto a plurality of specific rooms such as rooms 353. In order to avoid colorizing patent application drawings, FIG. 4 is presented with different shadings intended to reflect the appropriate colors, but herein we will discuss colorization. For example, a color blue 354 corresponds to a closed or complete status for the rooms. A grayish blue color 356 corresponds to a not closed status. A yellow color 358 corresponds to 1-10 deficiencies or punches outstanding in a room. A red color 360 corresponds to greater than 10 deficiencies or punches outstanding in a room. A purple color 362 corresponds to an uninspected status for a room.

Those skilled in the art will readily appreciate that other room coding schemes (different and more colors, shading) can be used to represent a variety of dynamic information in a format that is readily interpreted and thus very useful to the different parties involved in the process.

One embodiment of the present invention is a method for tracking deficiencies in the physical plants of hospitals. In this embodiment, inspectors are given tags to attach to deficiencies in the physical plant and to attach to the inspection record forms wherein the deficiencies are described and their status is indicated. The information contained in the inspection record forms is entered in the database, and is also provided to the general contractor responsible for the construction, commissioning, or transitioning of the physical plant facility. The general contractor arranges for correction of the reported deficiencies as described above with reference to FIG. 3. When the deficiencies have been corrected, the general contractor calls back the inspectors for verification, and the database is updated.

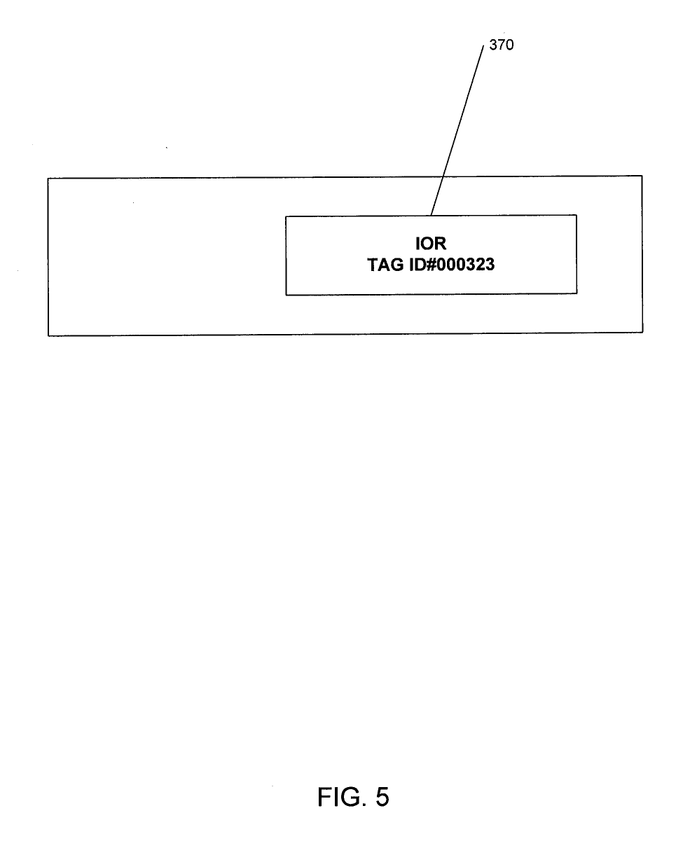

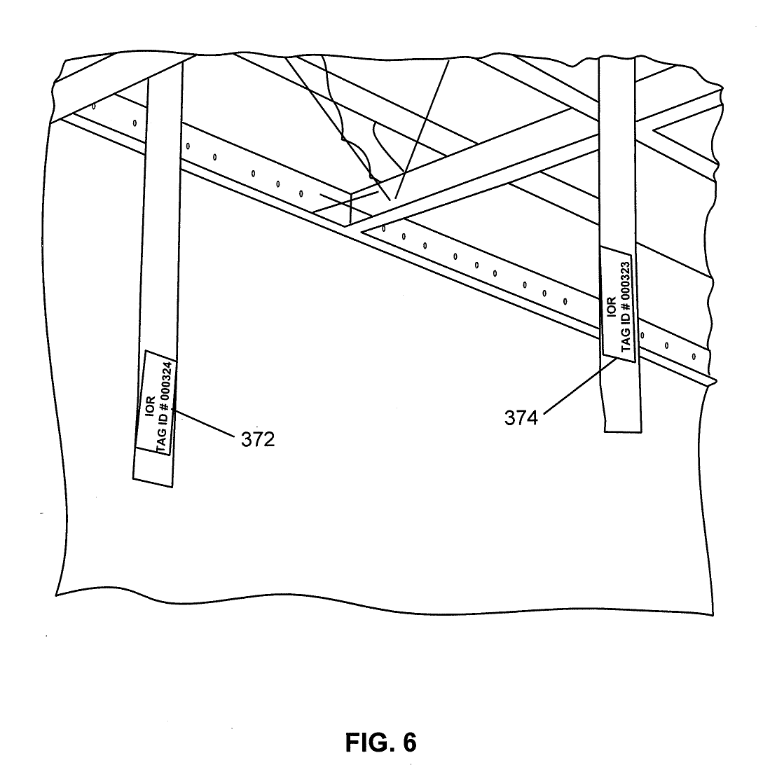

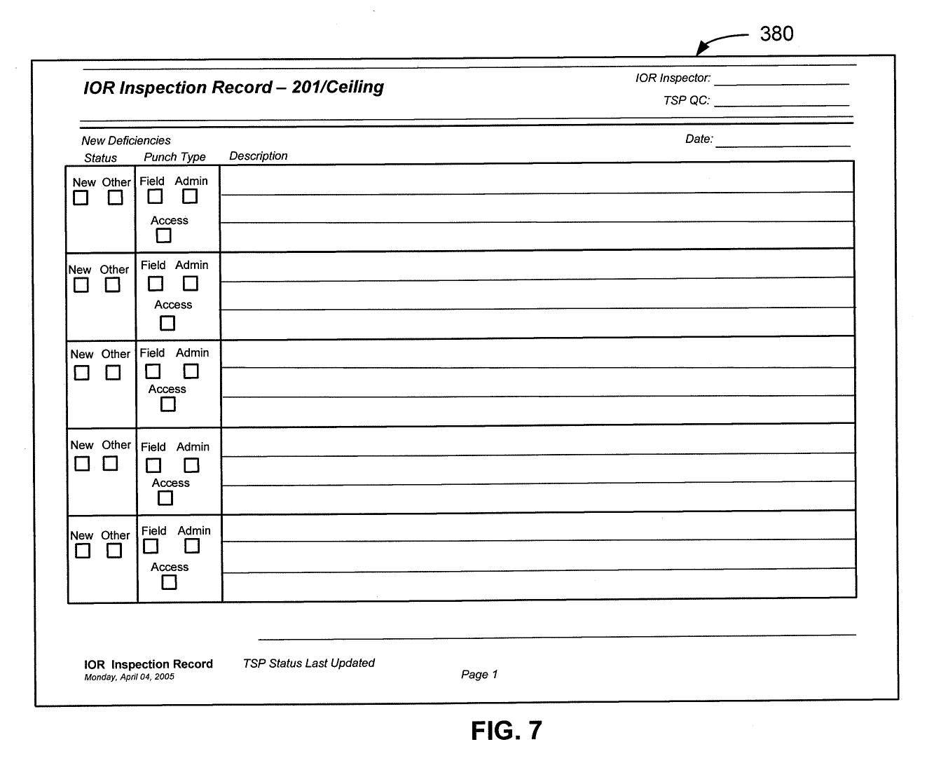

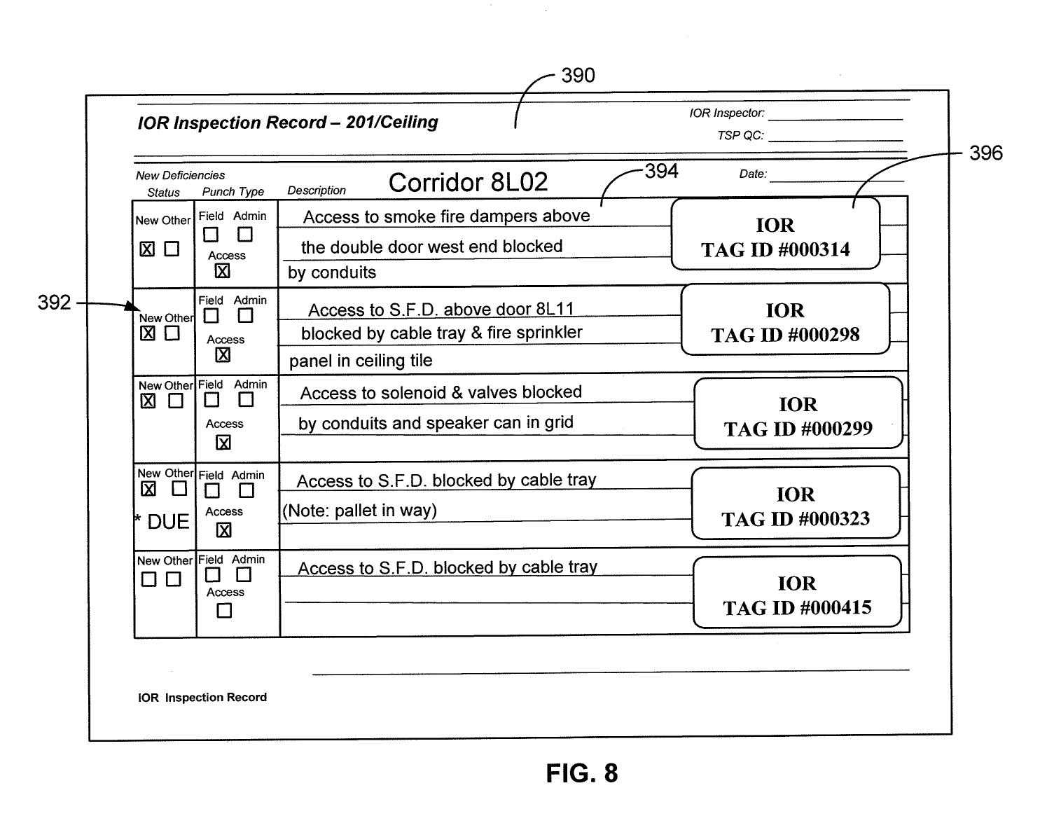

FIG. 5 illustrates a close up image of a tag 370 according to one embodiment of the present invention. The tag 370 has a unique identification number, and typically comes in duplicate-one tag for attaching on or physically near the deficiency, the other for attaching to an inspection record. FIG. 6 illustrates tags 372 and 374 applied to label a deficiency. FIG. 7 illustrates a blank inspection record 380 according to another embodiment of the present invention. FIG. 8 illustrates a partially completed inspection record 390. The inspection report includes checkbox fields 392 for entering standard data, description areas 394 for hand entry of information, and tag areas 396 for affixing a tag or entering tag id data.

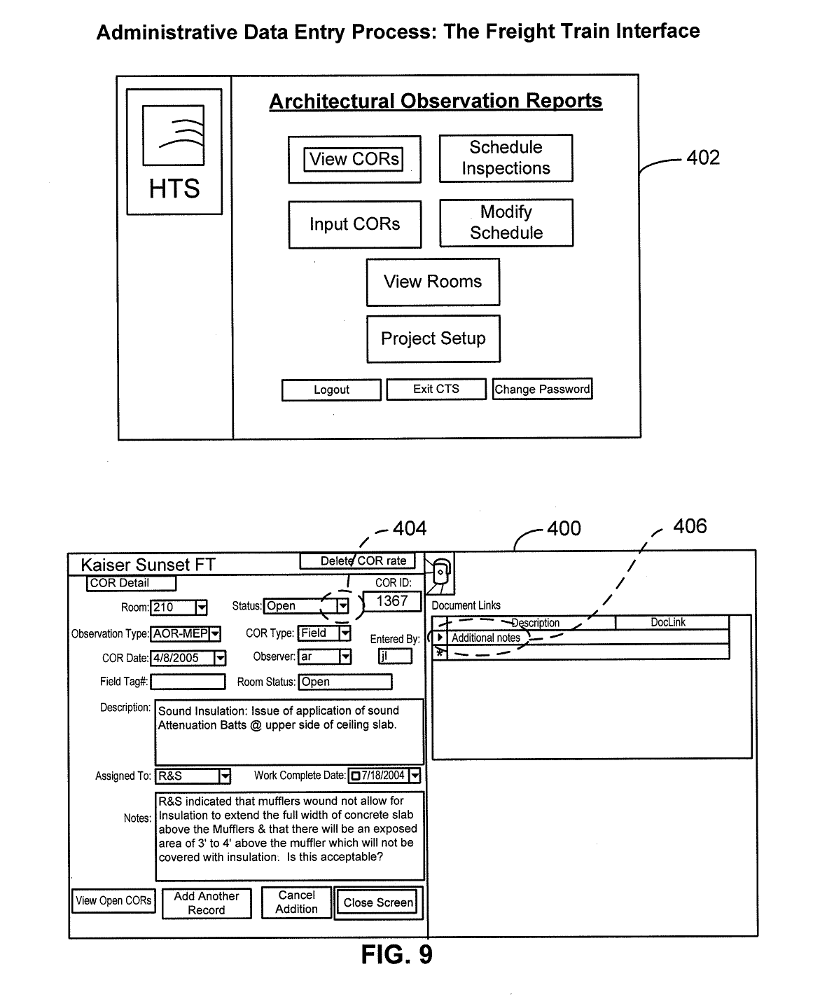

FIG. 9 illustrates two windows 400 and 402 available to a user of the present invention in entering data into the construction process management database of the present invention. These reflect the easy process by which users can manage dynamic data in the process of completing complex business process. The architectural observation reports window 402 allows the user to select from a variety of available data entry and status report generating mechanisms. The window 400 enables data entry as reported by an inspector or other party. Pull-down menus such as 404 allow for consistency in entering data into general field categories. Other data entry sections such as description 406 allow for manual entry of additional notes as well as linking abilities and image attachment.

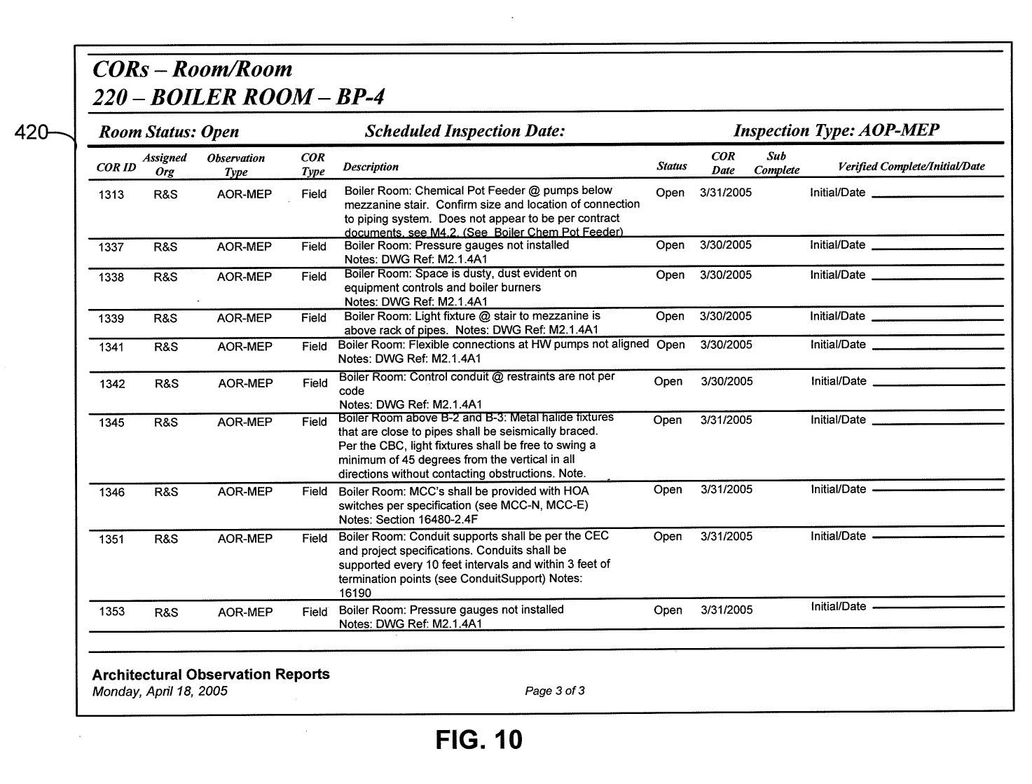

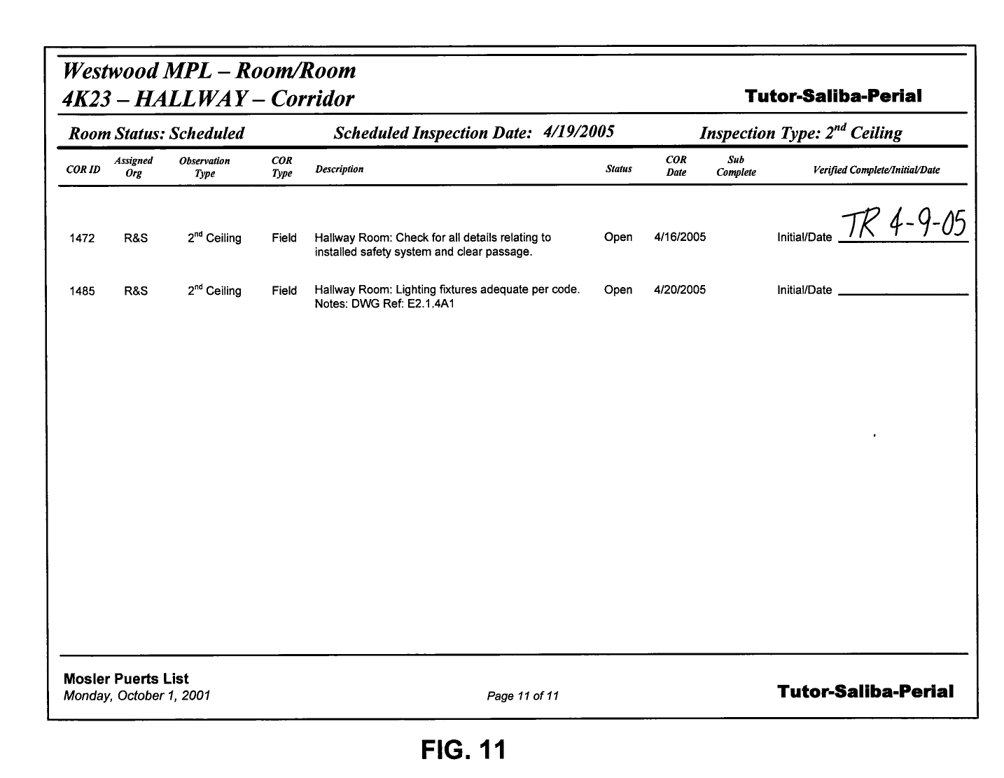

FIG. 10 illustrates a report 420 according to yet another embodiment of the present invention. The report 420 is generated through a process that allows sorting by a variety of parameters such as area, level, room type, responsible subcontractor, inspection type, deficiency type, and customized searches using keywords such as “rain water damage” or “core penetration,” and so forth. These reports can be distributed as needed, and as shown in FIG. 11, such reports can be posted in the field.

The methods and systems of the present invention are applicable to a wide variety of embodiments. These methods and systems can be used to track the business parameters associated with the physical plant of any large organization, can be used to track parameters other than deficiencies in the physical plant, and can be used in connection with activities other than construction, commissioning, and transitioning. For example, these methods and systems could be used to monitor the status of rooms, equipment, or furniture in the facilities of a corporation, government, university, or church, or to produce visual reports in which the rooms of such institutions are color-coded by room type, use, capacity, or ownership.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

### II. Layout and Database Initialization

Layouts of facilities and the associated database must be prepared and initialized for use. After such layouts have been produced, they may be imported into an appropriately configured computer system and the construction, completion, and transition operations described herein may be performed. An embodiment of a system constructed in accordance with the invention for performing these operations will be described next.

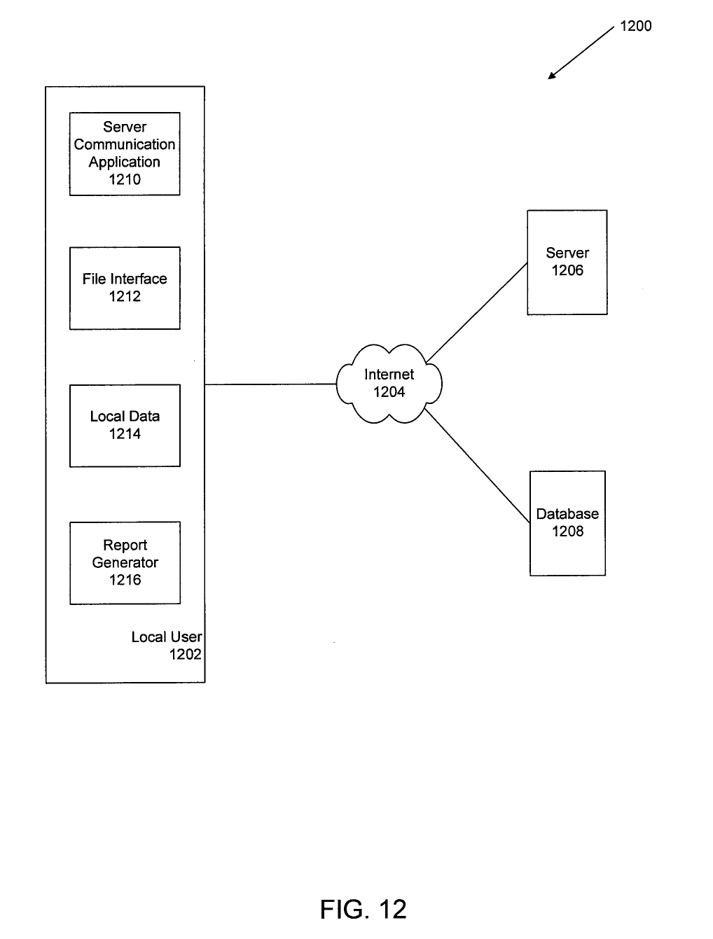

FIG. 12 is a block diagram of a system 1200 constructed in accordance with the present invention. A user at a network computer, referred to as a local user 1202, communicates over a network such as the Internet 1204 to an application server 1206 and a database system 1208. Those skilled in the art will appreciate that the network 1204 can comprise a local area network (LAN) or any other network suitable for communications between computers. Thus, the local user computer 1202 and the server 1206 and the database system 1208 will have network interface capabilities so as to enable communications between them over the network 1204. In this way, the local user, server, and database system comprise nodes of the network 1204.

The database 1208 can comprise, for example, a database that includes data maintained according to a database organization for retrieval of information according to a query language, such as the many commercially available database systems that operate according to Structured Query Language (SQL), and the like. The server 1206 is responsible for authenticating users and granting access to data files according to viewing rights of authenticated users. If a user cannot be authenticated, or if the user does not have viewing rights for a selected database, then the server 1206 will deny the user access to the database 1208. If desired, the functions of the server 1206 and database system 1208 can be integrated into a single network computer, or can be distributed among multiple computers. Similarly, the applications and features of the local user 1202 can be provided at the same computer that forms part of the server 1206 or database 1208.

In general, the computer at the local user 1202 can comprise any conventional desktop or laptop computer that has network communications ability with the server 1206 and database 1208. At the local user 1202, an installed application attends to communication between the local user, the server, and the database. For example, an Internet browser such as “Internet Explorer” by Microsoft Corporation of Redmond, Wash., USA can serve as a server communication application 1210 that facilitates communication with the server 1206 as well as file transfer between the two. To gain access to the drawing documents and other files associated with the construction, completion, and transition features of the system, the local user browser application 1210 contacts a network Web site or node corresponding to the file server 1206.

At the server 1206, a login process checks user credentials and authorization data for access to the desired files. After the server has authorized access, the user 1202 can communicate with the server through a file interface 1212 to request and obtain files. The file interface may comprise, for example, an application or a script or browser plug-in, and will be referred to herein as the “Visual Fragnet” application. In the illustrated embodiment, the “Visual Fragnet” comprises an application that can be launched from the server communication application, such as an Internet browser, without being installed at the local machine. Those skilled in the art will understand that so-called “click once” applications are in a category that provide suitable operations as the file interface 1212. That is, the file interface can comprise a Web application that is installed as a Windows (operating system) application.

Files can be retrieved from the server 1206 for viewing at the local user 1202 by conventional transport protocol techniques for network communications over the Internet. Copies of requested drawing files can be stored at the local user in local data storage 1214. At the local user, a report generator application 1216 can be used to generate colorized views of the drawing files and to render changes that reflect the state of the database 1208. That is, the report generator application displays the drawing files for viewing by the local user. The report generator application 1216 can comprise, for example, a graphical application such as “Visio” by Microsoft Corporation of Redmond, Wash., USA. Other suitable graphical drawing and visualization applications will be known to those skilled in the art.

Thus, the server communication application and file interface, in cooperation with the server, provide a user interface that enables a user to associate a poly-line representation of a facility floor plan having a plurality of shapes that correspond to contiguous areas of the facility floor plan with a database of business parameters relating to condition of the contiguous areas and that maps the business parameters of the database onto the contiguous areas of the poly-line representation. In addition, the report generator produces a visual representation of the facility floor plan in accordance with the business parameters mapping and that permits modifying the visual representation in accordance with updated business parameters values of the database. As described further below, the components illustrated in FIG. 12 provide the construction, completion, and transition tracking features in accordance with the present invention.

### A. Import Drawing into Viewing Application and Prepare Database

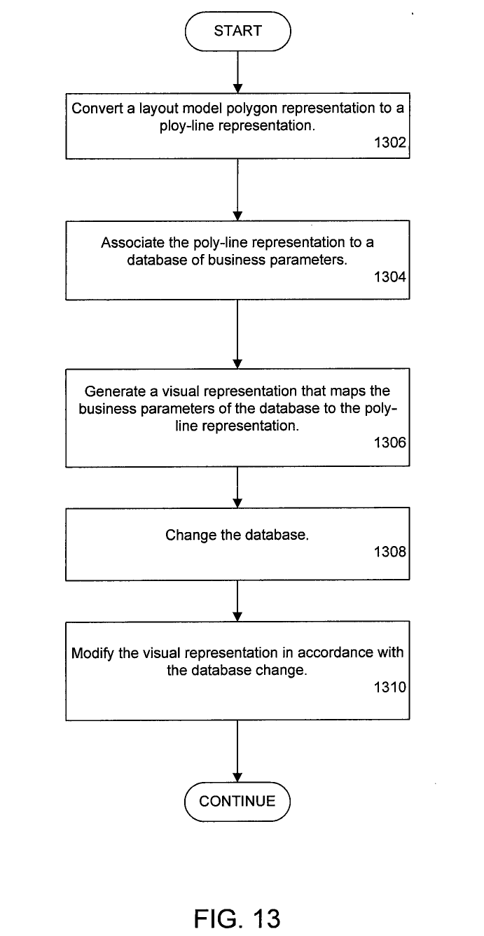

FIG. 13 is a flow chart that illustrates operations of the FIG. 12 system to provide the functionality described herein. In the first operation, represented by the diagram box numbered 1302, a layout model comprising a facility floorplan is converted from a polygon representation (such as a CAD file format) to a poly-line representation (such as a drawing or graphical file format). Those skilled in the art will be familiar with such processing, in which a CAD-based polygon representation of a floorplan is imported into an application that supports a poly-line representation format such that an overlay drawing can be formed of line-oriented shapes laid on top of corresponding contiguous areas of the floorplan from the polygon representation. For example, a CAD polygon representation file may be in a file format for the “AutoCAD” application from Autodesk, Inc. of San Rafael, Calif., USA. A line-oriented representation (a poly-line drawing) comprises a drawing layer in an application such as “Visio” that can be superimposed on a floorplan representation so that the poly-line drawing layer corresponds to contiguous areas of the floorplan such as rooms, hallways, closets, and the like. The poly-line representation of the floorplan can be stored in the database 1208 so that data management tasks and access control can be provided by the software of the database 1208 and by the server 1206.

In the next operation, represented by the FIG. 13 flow diagram box numbered 1304, the poly-line representation is associated with a database of business parameters. The business parameters can include identification data, such as room ID and room location according to the floor plan, and can include room status indicators, such as room name, room function, room construction status, room deficiencies, room readiness status, commissioning status, and the like. The database system can maintain data in a variety of formats, but generally will be organized according to row and column tables, such as spreadsheet format. The database can comprise a relatively simple construction, such as might be maintained by an application such as “Excel” and “Access” by Microsoft Corporation, or the database can comprise more complicated systems, such as commercially available database systems with access through a SQL interface and the like, such as provided by service vendors including Oracle, Inc. of Redwood Shores, Calif., USA, IBM Corporation of Armonk, N.Y., USA, and Sybase, Inc. of Dublin, Calif., USA.

Associating the poly-line representation with the database involves processing a list of the contiguous areas in the poly-line representation, such as a room list, and assigning values of the business parameters to each area, for storage in the database. For example, the FIG. 12 system permits a user to view a list of the contiguous shapes (rooms) of the floorplan poly-line representation and then assign each room a room name, a room location, a room ID, and other business parameters. The assigned values for the business parameters for each room are stored in the database. Corresponding values for the other business parameters can also be assigned to each area, either by user input, or by default values, or by combination of techniques. Thus, each contiguous shape of the floorplan corresponds to an area of the poly-line representation, so that each area has a corresponding row of a data table in the database, and each row includes a column for each of the business parameters, such as s room ID, room name, room location, construction status, deficiencies, readiness, and the like. In this way, each of the contiguous areas of the poly-line representation is linked to a row of the database.

B. Producing a Visual Representation of the Business Parameters

In FIG. 13, the next operation at box 1306 involves producing a visual representation that maps the business parameters of the database to the poly-line representation. That is, once the database entries corresponding to a poly-line representation of a particular floorplan have been populated, the rendering application (such as “Visio”) can produce a visual representation of the floorplan by producing a drawing that reflects the database values. For example, rooms of the poly-line representation will be located in the proper position of the visual representation in accordance with the location assigned in the database. Similarly, room ID and room name legends will appear on the visual representation in accordance with database values. Other database values can be placed or indicated on the visual representation in accordance with business parameters values and the drawing formatting. In the illustrated embodiment, a user can specify a drawing format in which colors can be assigned to different values of the business parameters. For example, a room readiness status of “ready” can be indicated on the visual representation by producing the visual representation with a green color for the floorplan area corresponding to the room. For a readiness status other than “ready”, the room can be produced with a different color, such as red.

The business parameters values in the database can be changed at box 1308. For example, room status information such as room name, room function, room construction status, room deficiencies, room readiness status, commissioning status, and the like can be changed in the database. As described further below, the database change can be implemented by a user by making drawing changes to the visual representation or can be implemented by database editing functions supported by the database system itself.

Lastly, at box 1310, the visual representation of the floorplan is modified in accordance with the change in the database. For example, if the readiness status of a room was changed at box 1308 from “ready” to “not ready”, then the color of the corresponding room in the visual representation would be changed from green (at box 1306) to red (at box 1310). The change in the database is reflected in the visual representation at the time the viewing application renders the visual representation. That is, if the visual representation is rendered at regular intervals by checking values in the database, then the visual representation is updated or modified at corresponding intervals. If changes to the database are pushed to the viewing application as the changes are made, then the visual representation is updated accordingly.

### III. Viewing the Visual Representation

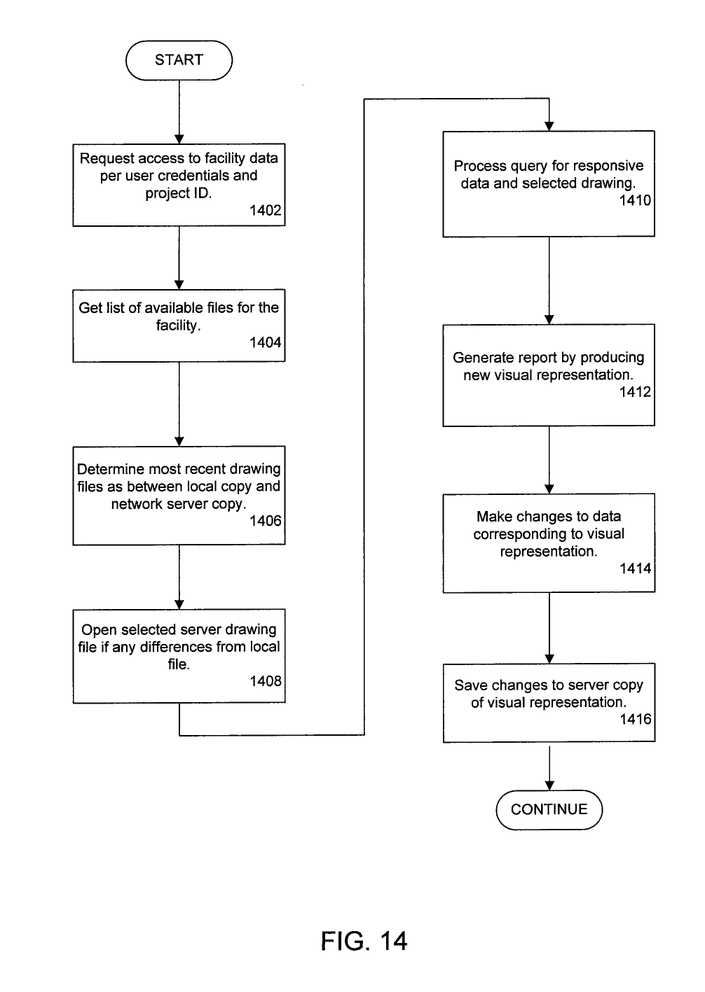

After the poly-line representation has been linked to the database and the visual representation is produced, users can gain access to the drawings and the database for generating reports and viewing the data. These operations are illustrated in the FIG. 14 flow diagram.

### A. Open the Facility File

In the first operation, represented by box 1402 of FIG. 14, a local user communicates with the server and requests access to data for a facility, such as a building project site. As noted above, the server communication application 1210 (FIG. 12) with which the user requests access can comprise a Web browser, such that the user navigates to a Web site for the data. Upon viewing the Web site, the user submits identification credentials and project identification information to the facility data server 1206 through the browser interface. The data server checks stored data for the user and facilities that it manages. If the user cannot be authenticated or if the user is not indicated in the stored data as being granted access to the requested facility, then the access request is denied and processing ends.

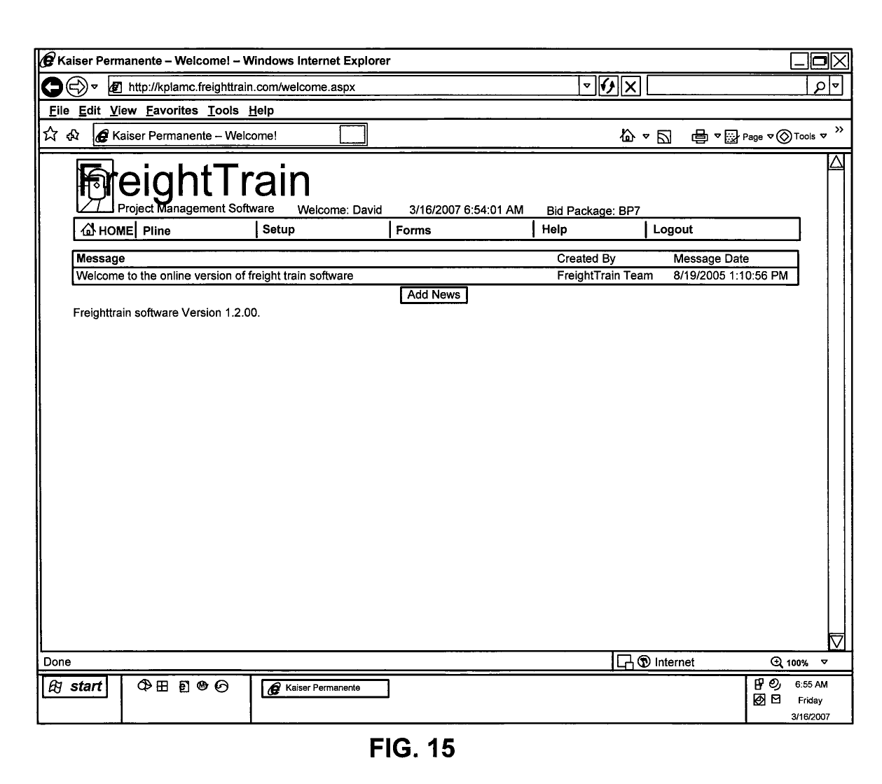

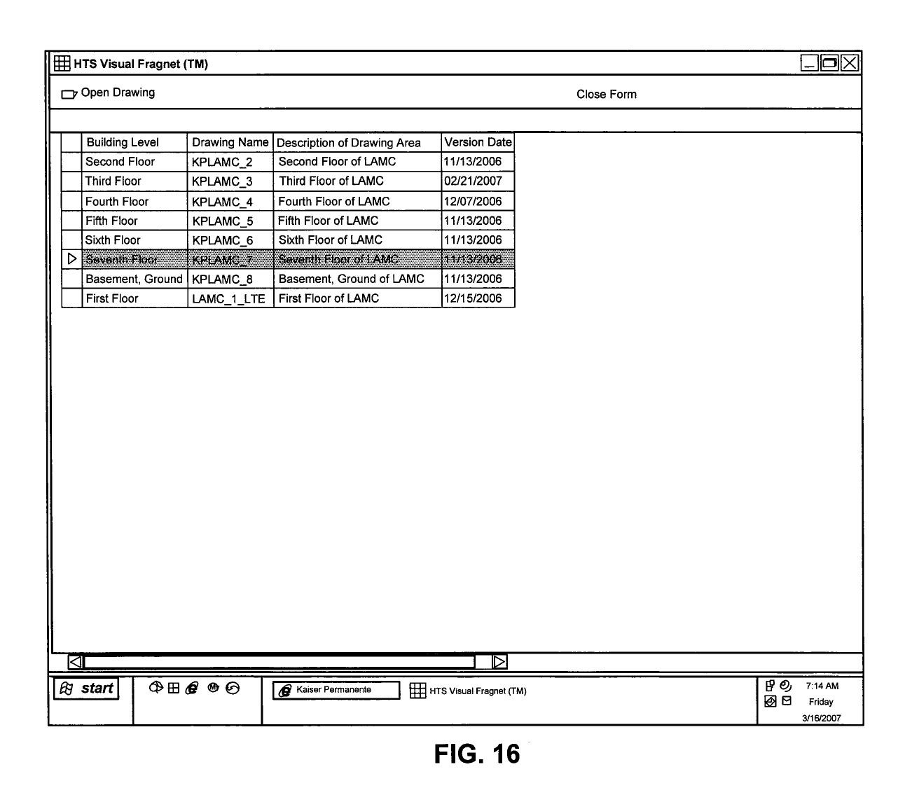

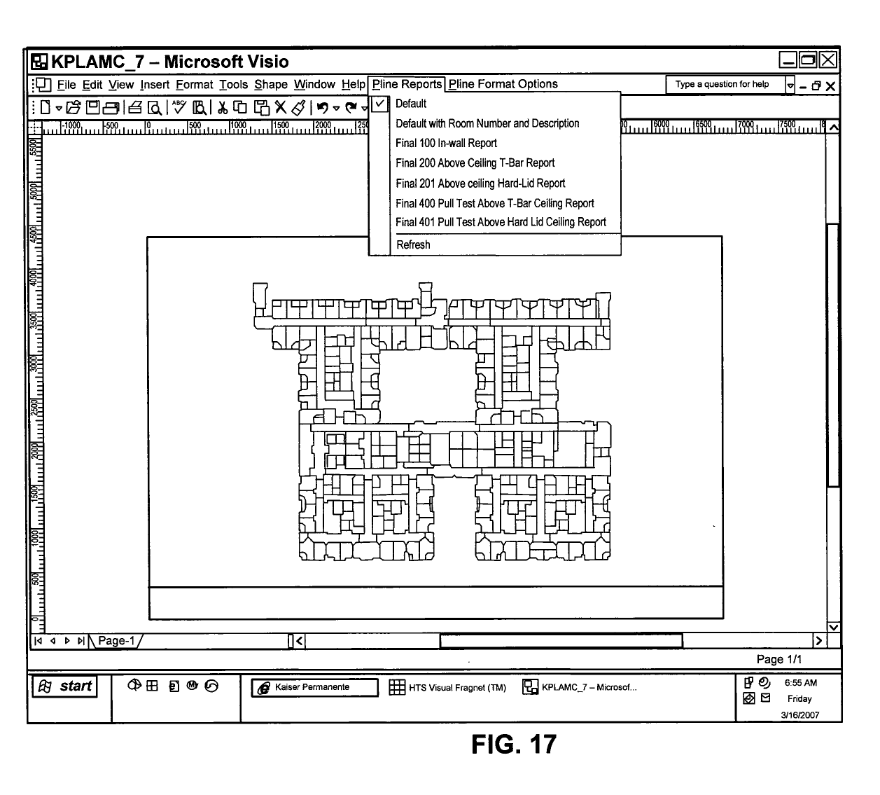

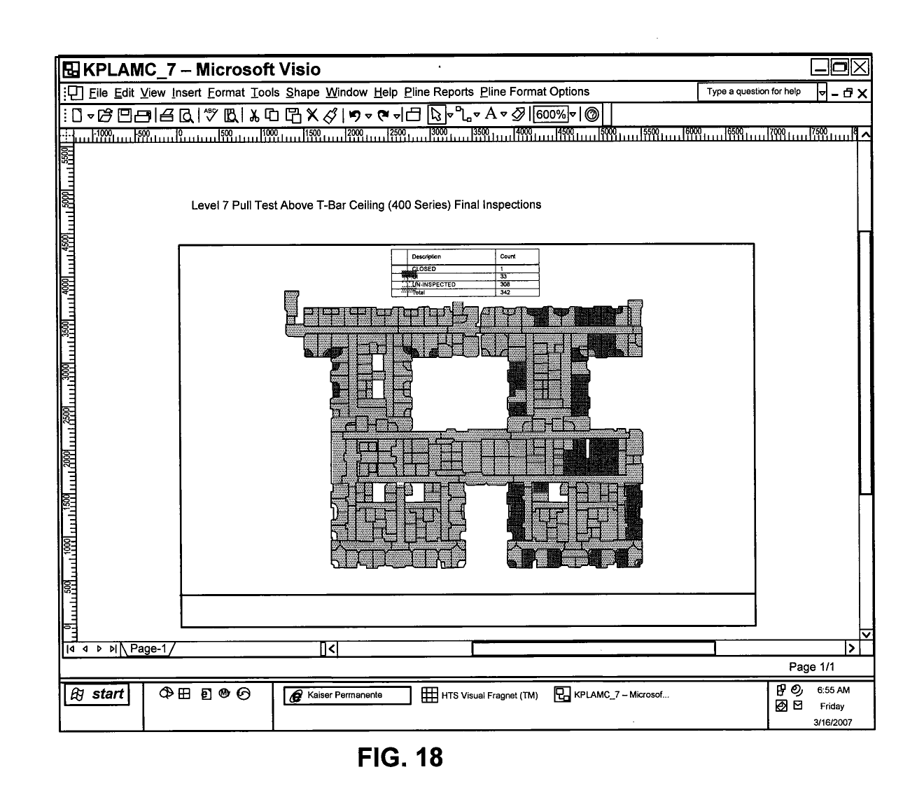

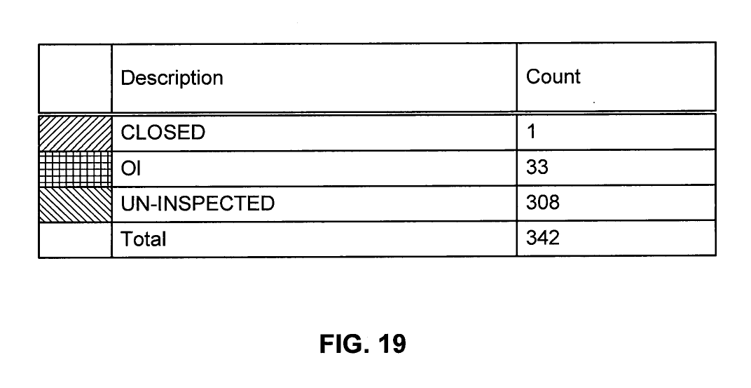

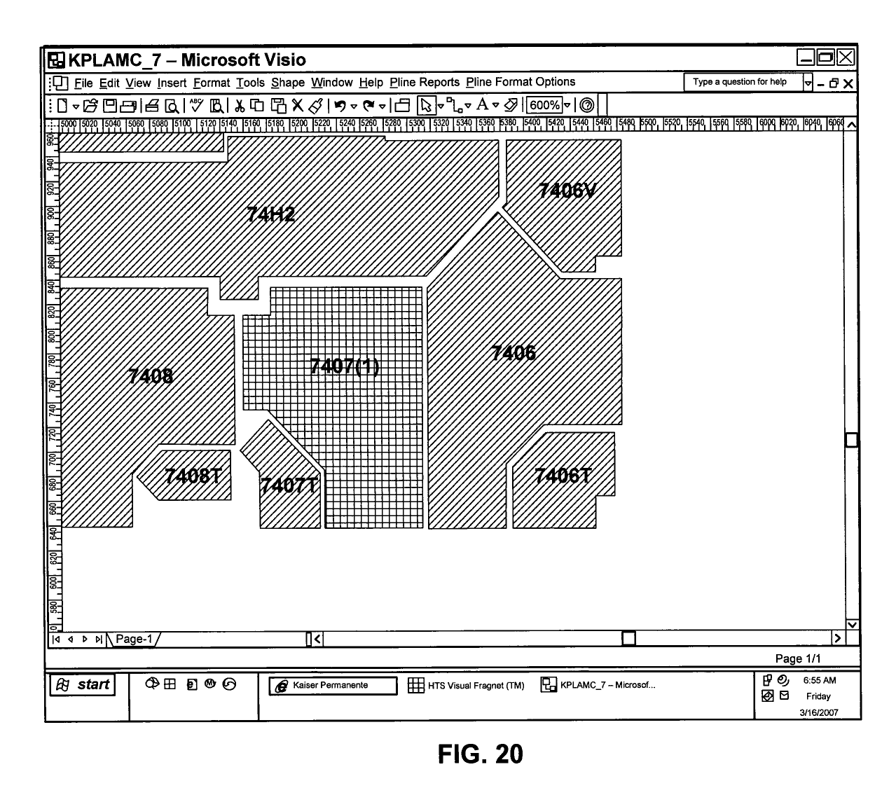

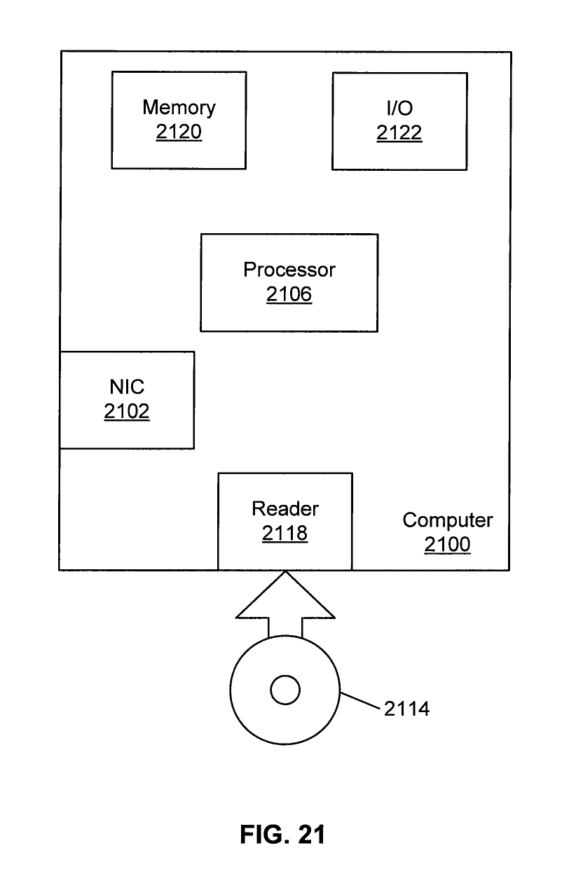

If the user is authenticated and has been granted access to the requested facility building project, then at box 1404 of FIG. 14 the server will provide the user with information through the computer display of the local user through which the user may interact with files for a selected facility or project. FIG. 15 shows a computer display of the server communication application at the local user for a selected project. All of the local user computer display illustrations, such as FIG. 15, have been simplified for understanding and do not necessarily include all details of actual implementations, but features for understanding the present invention are shown and described herein.

In the FIG. 15 illustration, the Web site for the requested facility files is identified as “FreightTrain”, available through HTS, LLC of Los Angeles, Calif., USA. Selecting the “Pline” tab of the FIG. 15 Web page generates a request to the server for data from which poly-line representations of the corresponding facility or project can be produced. In response, the file interface is downloaded from the server to the computer if the file interface is not already installed or if an updated version of the file interface is available. After the file interface installation (or confirmation of same), the local user receives data for the requested project, and the file interface 1212 (FIG. 12) automatically displays the information in a new display window of the computer. That is, the server determines if the file interface is present at the local user. If the file interface is not present, then the file interface is downloaded from the server to the local user and is installed. FIG. 16 shows a computer display of the local user machine and identifies the file interface as “Visual Fragnet”, a downloadable and installable application available from HTS, LLC.

In particular, FIG. 16 shows a display produced from data for the requested project, indicating that the poly-line representations for the requested project are organized according to floors of the facility. FIG. 16 shows that the selected project comprises a building that includes a basement, a ground floor, first floor, and second through seventh floors. The user can select one of the poly-line representations for viewing. The received data is downloaded on demand by the computer user when the user selects a floor in the menu of FIG. 16 and clicks on the “Open Drawing” display button. FIG. 16 shows that the seventh floor has been selected. If a selected drawing (such as the seventh floor) has been selected, the drawing data is downloaded to the user computer and maintained as a local copy. As explained further below, on subsequent selections of the same drawing, the drawing data is not downloaded again, but the local copy is opened in the file interface. The exception to this processing is when a change is made to the drawing template (that is, in the database). In that situation, a new set of drawing data is downloaded through the server.

Once a drawing (i.e., Seventh Floor in FIG. 16) has been selected, a user can select from menu options according to operations for which the user has been authorized. In FIG. 16, the menu options include Open Drawing, Administer Drawing, New Drawing, Delete Drawing, Edit Drawing Description, Work Off-Line, and Close Form. The Open Drawing option permits the user to open (view) the selected drawing. The Administer Drawing selection permits associating the rooms and spaces of the selected floor with corresponding entries in the database. The other options are self-explanatory. The received data can be viewed through the combination of the file interface (such as the “Visual Fragnet” application) and the report generator. For example, the “Visual Fragnet” application can be installed and executed at the local user computer and, upon installation, the report generator application (such as the “Visio” application) will include the menu options that are illustrated in FIG. 16 and that are not otherwise generally available to users.

When the user selects a poly-line representation, such as the seventh floor of the building, the file interface 1212 at the local user, or some other designated local application, determines if the local copy of the requested poly-line drawing file stored in the local data 1214 (FIG. 12) is more recent than the corresponding drawing file stored at the server 1206. That is, the local user computer 1202 maintains a cache for storing drawing files, so that network traffic and bandwidth requirements are reduced. Thus, the local user file interface 1212 can check the local cache 1214 to see if the requested poly-line drawing file is stored in the cache. If a local copy exists in the cache, then the local user file interface application can determine the more recent drawing version by checking a timestamp of the cache copy for time of last edit, and comparing against the corresponding timestamp of the drawing file copy through the server 1206.

Timestamp discrepancies can be resolved in different ways at box 1408, depending on system preferences. For any discrepancy, the server copy can be retrieved to overwrite the cache copy. Alternatively, the most recent timestamp value (e.g. time of last edit) can be used to overwrite the older copy, whether server copy of cache copy. In anther alternative, the cache copy can be used to overwrite the server copy only if the local user has administrative rights for the system. The particular discrepancy resolution processing at box 1408 can be selected as a system preference by a system administrator. In conjunction with the box 1408 processing, the requested drawing file can be opened by the viewing application, such as by the report generator application, at the local user.

Once the proper drawing file is identified, system processing at the local user computer passes the drawing to the report generator application, such as the “Visio” application. The selected drawing, indicated in FIG. 16 as the seventh floor, is rendered and displayed in the report generator application. FIG. 17 shows a local user computer display of the report generator application as configured in accordance with the present invention. FIG. 17 shows that appropriate menu bar options are provided, through which the user can adjust the views (reports) of the drawings. For example, FIG. 17 shows a “Pline Reports” drop-down menu to permit user selection between a default view and various report categories. The report categories will be generated in accordance with business parameters data at the database. Other format options may be selected, such as drawing color options, fill patterns, drawing adjustments, and the like. It should be apparent that the user will have all the drawing customization and manipulation features available that are provided by a conventional instance of the report generator application. For example, in the case of the “Visio” application for the FIG. 12 system, the local user can manipulate the drawing using the Visio-available drawing commands, as well as the Pline Reports and Pline Format Options described herein.

Selecting any of the “Pline Reports” options illustrated in FIG. 17 automatically generates a database query that returns data from the database with which the rendered poly-line representation is modified. In the illustrated embodiment, the local user 1212 provides the database query to the server, which in turn retrieves the corresponding data from the database. When the server provides the data to the local user, the report generator produces the display drawing. FIG. 17 shows a default view in which none of the rooms and spaces in the produced floorplan drawing have been colorized. FIG. 18 shows the same floorplan representation after the “Pull-Test Above T-bar Ceiling Report” has been selected from FIG. 17. In the drawings, cross-hatching is generally used to indicate colorization for this non-color representation. It should be understood that color can be used to great effect in place of the cross-hatching, providing a less cluttered view. FIG. 18 includes a drawing legend box 1802 that identifies shading (color) in the report drawing with corresponding data value. The drawing legend box is illustrated in greater detail in FIG. 19.

B. Database Queries and Reports

As noted, selecting a report from the “Pline Reports” menu automatically generates a database query that results in producing the corresponding report. If the requested report is not a default (non-color) drawing, then the report generator receives data with which it produces a colorized rendering, in accordance with the requested report (query). The report query is represented in FIG. 14 at box 1410, which shows the local user report query being processed for the requested data file by the file interface application of the local user in conjunction with server processing to retrieve business parameters data in the database for the requested drawing file. In this way, the local user can request data for a particular floor of a building and can request data that indicates room readiness status. The file interface application and server processes respond to the request as part of the box 1410 processing and provide the data or other information necessary for the report generator to produce an appropriate visual representation of the drawing file according to the requested data. When the report generator receives the data that corresponds to the requested report query, at box 1412 the report generator produces a new visual representation comprising a report for the data file in response to the query. FIG. 20 shows a detail of the FIG. 18 drawing, showing colorization details (represented in the illustration by cross-hatching) for spaces comprising rooms, hallways, closets, and the like. The FIG. 20 representation can be produced by the local user through manipulation of the drawing features of the report generator application for enlargement, shifting, and the like.

A user can change the way the drawing appears, as indicated at box 1414. An authorized user can make changes to the database through the file interface application, via the user interface of the viewing application. A user who is authorized to make database changes will be presented with appropriate menu options in the file interface (FIG. 16) and through the viewing application (FIG. 17). An authorized user can select an area of a drawing in the viewing application, such as a room or a set of rooms or areas, and gain access to a database change menu through a menu option. In the illustrated embodiment, the file interface application or a server application will receive the changed value and will store the corresponding change in the database. Upon making the database change at the user and closing the menu option window, the drawing will be subjected to a refresh operation, and the drawing will be updated with the changed database value. For example, the status of rooms may be changed from “open” to “closed”. It should be noted that database changes also may be performed through database application interfaces and database management applications, as known to those skilled in the art. In addition to changing appearances through database changes, a user can also change the appearance of the drawing being viewed without changing the database. A user can make a change to the visual representation through the viewing application. This action does not result in a change of values in the database. Those skilled in the art will appreciate how to use a viewing application such as Visio to make changes to the appearance of a drawing. For example, a user might make a change to color preferences so that different colors are associated with a particular room status. In this way, a user might change the color for rooms indicated as “open” from red to blue. In that case, all downloaded drawings viewed in the viewing application at the user would show “open” rooms as blue. Rooms in the database that have a value of “open” would remain in that status. That is, the actual status value in the database is not changed by a change in user viewing preference in the viewing application.

At box 1416, changes to the local copy (cache) of the drawing are saved at the server to ensure drawing accuracy for the next visual representation. In general, local user changes of a drawing are saved to the server only if the local user is identified as having administrative rights. Thus, only authorized users will be permitted to change server copies of drawings. This reduces the chance of inadvertent drawing changes and ensures that only drawing changes that are authorized by an administrator will get stored in the database.

A variety of hardware configurations can be used for the devices described above. For example, conventional server, desktop, and laptop computers can be used for the server 1206. Those skilled in the art will understand the computing requirements and the corresponding machine configurations suitable for the server 1206, database 1208, and local user 1202. In the illustrated embodiments, the computers generally operate in accordance with the “Windows XP” operating system available through Microsoft Corporation, but other suitable operating system can also be used. Other details of construction and operation will occur to those skilled in the art in view of the description herein. Those skilled in the art will appreciate that a wide variety of device operating systems other than “Windows XP” can provide a suitable environment for execution of the operations described herein. Thus, any computer device that can perform the operations described herein can be utilized in a system constructed in accordance with the present invention.

FIG. 21 shows a configuration for a computer 2100 constructed in accordance with the present invention. The computer can perform the functions of the devices illustrated in FIG. 12. The computer 2100 includes a network communication interface 2102 that permits communications with a network. The network interface can comprise a network interface card (NIC). The computer includes a processor 2106 that can receive program instructions for proper operation into the program memory of the processor. The processor 2106 comprises a computer processor chip and associated circuitry and related components, such as program memory, data memory, central processor unit, and the like. The processor 2106 enables the computer 2100 to operate in accordance with the description herein via execution of appropriate program instructions.

The program instructions can be received directly, such as by flashing EEPROM of the processor, or can be received through the network interface 2102, such as by download from a connected device or over a WAN or LAN network communication. Once the program instructions are installed in the computer, the instructions can be executed by the processor 2106 so as to operate in accordance with the methods and operations described herein. If desired, the program instructions can be stored on a computer program product 2114 that is read by a reader 2118 of the computer 2100 so that the program instructions can be received into the program memory of the computer. That is, the program product 2114 is for use in a computer system such as the computer 2100, wherein the program product comprises a recordable media containing a program of computer-readable instructions that are executable by the computer processor 2106 to perform the operations described herein. The program product 2114 can comprise, for example, optical program media such as CD or DVD data discs, or flash memory drives, or external memory stores, or floppy magnetic disks, and the like. The computer also includes associated data storage 2120, such as disk storage and data memory, and input/output facilities 2122, such as a display and keyboard.

Thus, the system described herein provides a user interface that enables a user to associate a poly-line representation of a facility floorplan, having a plurality of shapes that correspond to contiguous areas of the facility floorplan, with a database of business parameters relating to condition of the contiguous areas. The system includes a report generator that generates a visual representation of the facility floorplan. The visual representation maps the business parameters of the database onto the contiguous areas of the poly-line representation. Modifications to the database produce modifications to the visual representation through the user interface and report generator in accordance with updated business parameters values of the database. In this way, changing business parameters values in the database can be tracked and viewed in a report that provides a visual representation. In accordance with the invention, the visual representation includes colorized features such that colors are associated with particular values or states of the business parameters in the database.

The present invention has been described above in terms of presently preferred embodiments so that an understanding of the present invention can be conveyed. There are, however, many configurations and techniques for management of facilities construction, commissioning, and transitioning that were not specifically described herein, but with which the present invention is applicable. The present invention should therefore not be seen as limited to the particular embodiments described herein, but rather, it should be understood that the present invention has wide applicability with respect to facilities construction, commissioning, and transitioning generally. All modifications, variations, or equivalent arrangements and implementations that are within the scope of the attached claims should therefore be considered within the scope of the invention.

We claim:

1. A computer-implemented method for data management of business parameters of a facility, the method comprising:
converting a layout model in a polygon representation into a poly-line representation of shapes in a viewing program;
linking the poly-line representation to a database containing metadata for each of the shapes;
performing a search of the linked database in response to a database query and producing a query response;
changing the visual representation of the poly-line representation in accordance with the query response.

2. A method as defined in claim 1, wherein the poly-line representation is stored as a data file of a graphical application program.

3. A method as defined in claim 1, wherein the poly-line representation relates to a facility floorplan having a plurality of shapes that correspond to contiguous areas of the facility floorplan.

4. A method as defined in claim 3, wherein the database contains data for business parameters relating to condition of the contiguous areas.

5. A method as defined in claim 1, wherein linking includes assigning identifiers to the shapes.

6. A method as defined in claim 5, wherein the assigned identifiers refer to corresponding records in the database.

7. A method as defined in claim 1, wherein linking is performed with a viewer window of the viewing program.

8. A method as defined in claim 7, wherein the viewer window determines an appropriate visual representation to present in accordance with the database query.

9. A method as defined in claim 1, wherein the database query relates to status of the shapes.

10. A method as defined in claim 9, wherein changing the visual representation comprises changing the color of the shapes in accordance with the status of a shape.

11. A method as defined in claim 1, wherein the layout model relates to a building architectural plan.
